(19) United States
(12) Patent Application Publication
(10) Pub. No.: US 2008/0237069 A1
(43) Pub. Date: Oct. 2, 2008

(54) Cap For Protecting The Bristles On The End Of A Paintbrush Or The Like

(75) Inventors: Bertrand Barre, Lapeyrouse (FR); Francis Lepage, Dommartin (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ARJOWIGGINS CANSON, Annonay (FR)

(21) Appl. No.: 10/586,761

(22) PCT Filed: Jan. 20, 2005
(86) PCT No.: PCT/FR2005/000122

§ 371 Date: Feb. 12, 2007

(30) Foreign Application Priority Data
Jan. 22, 2004 (FR) 0400573

(51) Int. Cl. A46B 17/04; B44D 3/12; B65D 85/00; B65D 51/26; B65D 25/10

(52) U.S. Cl. 206/15.3

(57) ABSTRACT

The invention relates to a cap for protecting the bristles (1) of a paintbrush (1, 2, 3). Said cap comprises a housing (7, 8) consisting of two shells (7, 8) that are joined to each other in an articulated manner in order to close the housing (7, 8) by adjacently superimposing the shells (7, 8). One (7) of the shells, which is fixed, is extended by a rigid cradle (6) for receiving a ferrule (3) of the paintbrush, said cradle (6) being provided with elements (4, 5) at the ends thereof, for respectively gripping the ferrule (3). The other shell (8), which is mobile, is provided with a locking element (16) at the distal end thereof, which co-operates with a complementary locking element (17) pertaining to the fixed shell (7), by nesting therein in the closing position of the housing (7, 8), said locking elements (7, 8) projecting radially.

The invention relates to the field of caps for protecting the end of a paintbrush or the like. Its subject is an easily removable cap of this type that nevertheless offers effective, long-lasting protection for the end of the paintbrush, particularly for the purposes of carrying it.

It will be recalled that a paintbrush is formed principally from a handle that at its distal end carries bristles that are held on the handle by means of a ferrule. Here, and in the remainder of the description of the invention, the term “bristles” must be understood in the general sense and describes all types of fibers used to manufacture the end (also called the tuft) of the paintbrush, these fibers being natural and/or synthetic. One general problem lies in the fragility and flexibility of the bristles, making it useful for them to be protected when the paintbrush is not being used, particularly during the latter's transportation. To that end, the prior art has proposed caps for protecting the bristles that can be attached reversibly onto the paintbrush handle.

It will be pointed out at this stage of the description of the present invention that a cap of this type must be a compromise between the various qualities offered by its structure. These qualities are, in particular, effective protection of the bristles, the long life of the cap despite its frequent and regular handling, its firm fixing onto the paintbrush handle, which must nevertheless not hamper its easy removal, its comfortable handleability, which is necessary in order not to prohibit its use, and its pleasing shape and outer appearance that are capable of attracting a user, who is deemed to be sensitive to esthetics, given the field of application of the paintbrush—painting art, or even make-up or the like.

A cap arranged as a cylindrical sleeve for capping the bristles as soon as it is slipped onto the handle, for example, has been proposed. One drawback connected with the use of a cap of this type lies in its passage over the handle from one or other of the ends of the paintbrush. Indeed, it would appear that passage of the sleeve counter to the direction in which the bristles lie, starting from the distal end of the paintbrush, inevitably gives rise to detrimental deformation and/or damage to the bristles, whereas passage via the proximal end of the paintbrush, as proposed by document FR 2 642 283 (da Vinci), is unsuitable and awkward to use. Furthermore, ways of installing the cap such as these render advantageous equipping of the proximal end of the paintbrush handle with an accessory of sizeable lateral dimensions, such as an artist's scraper, pallet or knife, for example, impossible.

It has thus been proposed by document DE 4 215 896 (Foerster) to organize the cap as a housing consisting of shells articulated together and deformable in order for them to nest together, interacting by means of overlapping. The housing is fixed on the paintbrush handle by means of joint gripping of the latter by the shells in the closed position of the housing, by means of deformable sleeves slipped forcibly over the handle. The antagonism of the forces present in order, on the one hand, firmly to lock the housing in the closed position and, on the other hand, to fix the latter on the paintbrush handle will be noted.

It has also been proposed by document DE 206 635 (Meier) to organize the cap as an extended spoon-bowl of a deformable cradle in order to fix it by means of lateral nesting over the paintbrush handle. A cap of this type offers only partial protection of the bristles and the ways in which it is used in order to be fixed and removed render it tricky to handle and its long-term efficiency doubtful.

It would appear from the aforesaid that caps of this type do not offer the above mentioned satisfactory compromise, the consequence being that users tend not to use them on a daily basis.

An object of the present invention is to propose a cap, for protecting a paintbrush, that meets the requirements in the field and is based on a structure of the cap that best complies with the requirements of the abovementioned compromise in order to enable it to be used by users under satisfactory conditions.

According to the present invention, a cap for protecting the bristles on the end of a paintbrush includes the following characteristics, taken alone or in combination:

1) the cap includes a housing with, on the one hand, means for its easily reversible fixing on a ferrule provided at the distal end of the handle of the paintbrush and, on the other hand, two shells articulated together at one of their ends and capable of being folded down one toward the other in order to close the housing;

2) one of the shells, which is fixed, is extended by a rigid cradle for receiving the ferrule, this cradle forming, in particular, a soleplate for receiving the other shell, which is movable, and being provided, at least in the vicinity of its respective ends, with distant members for respective gripping of the ferrule by means of elastic deformation of the members;

3) the housing being provided with means for locking its closure by means of mutual nesting of the shells, the movable shell is provided at its distal end with a member for locking in the closed position of the housing, which interacts by means of nesting with a complementary locking member of the fixed shell, such that in the closed position of the housing the shells are held in juxtaposed superimposition, one against the other, at the periphery of their orifice.

Furthermore, the cap of the invention includes the following secondary arrangements:

The gripping members are composed preferably of a proximal member for gripping at least with an axial stop interacting with a complementary relief of the ferrule, and of a distal member for gripping at least with radial retention by means of localized peripheral gripping of the ferrule. These arrangements are such that the attachment of the proximal gripping member on the handle of the paintbrush gives this member a pivot-point function, about which the cradle tilts as far as radial gripping of the ferrule by the distal gripping member.

Furthermore, the gripping members of the cradle are advantageously organized in the form of jaws of which the clamping parts are arranged as at least one radial lip, the profile of which is preferably faceted in order to grip the ferrule via distant points.

The cradle preferably includes, on its outer face, a dorsal stiffening rib for increasing its robustness. This dorsal rib extends, in particular, from the proximal end of the cradle toward the area where the cradle joins the fixed shell. Preferably, the outer face of the fixed shell and the dorsal rib are substantially flush.

The locking members of the shells each consist more precisely of a set of lateral reliefs antagonistic to radial extension, which are, respectively, provided at the corresponding ends of the shells in a substantially radially median area of the housing.

Preferably, the housing is provided with means for guiding the movable shell between the open and closed positions of the housing, said guide means consisting of interacting guide members of the shells, respectively, at the periphery of their orifice. These members are advantageously formed by a rabbet for mutual superimposed positioning of the shells, provided along the periphery of the orifice of at least either one of the shells in order to receive the edge of the other shell.

It will be noted that this rabbet at least is preferably continuous for regular, uninterrupted guiding of the movable shell or is otherwise discontinuous, being composed of successive distant elements.

The movable shell advantageously includes lateral gripping wings enabling it to be gripped and handled at least when the housing is opened, or otherwise also closed, by the user. Preferably, the lateral gripping wings are provided as an extension of the lateral reliefs of the movable shell. These arrangements also make it possible to strengthen the distal end of the movable shell forming an orifice for the passage of the handle, which is subject to repeated deformation stresses for closure locking of the housing, unlike the corresponding end of the fixed shell, which is strengthened by means of its securing to the cradle.

At least either one of the shells advantageously includes ventilation openings, particularly shaped as axial slots, such that said openings allow a sizeable circulation of air, without thereby significantly adversely affecting the stiffness of the shell, through the wall of which shell the ventilation openings are provided.

According to a particular embodiment of the invention, the cap includes an air passage to allow, in the closed position, a circulation of air, particularly via its distal end, this passage preventing the risks of suffocation in the event of accidental ingestion of the cap. More particularly, said air passage is formed by opposite openings made, respectively, through the fixed shell 7 and the movable shell 8.

According to a preferred embodiment of the invention, the protective cap is produced from elastically deformable plastics. Advantageously, said plastics is transparent. By way of transparent plastics, mention may be made, for example, of polypropylene, polycarbonate, polystyrene, acrylonitrile butadiene styrene polymer (ABS) and polyamide. According to a preferred embodiment of the invention, said protective cap is made from polyamide. This latter elastically deformable, transparent plastics has the advantage of retaining its mechanical elasticity properties and therefore enables the cap according to the invention to be easily adapted to different diameters of paintbrush. Moreover, polyamide is a material with the particular feature that it is resistant to solvents and thus proves to be a particularly suitable material for the invention.

According to a preferred embodiment of the invention, the protective cap made from transparent plastics is produced by means of molding.

The present invention will be better understood and the details will become more apparent with the description that will be given of a preferred embodiment, in connection with the figures of the appended plates, in which:

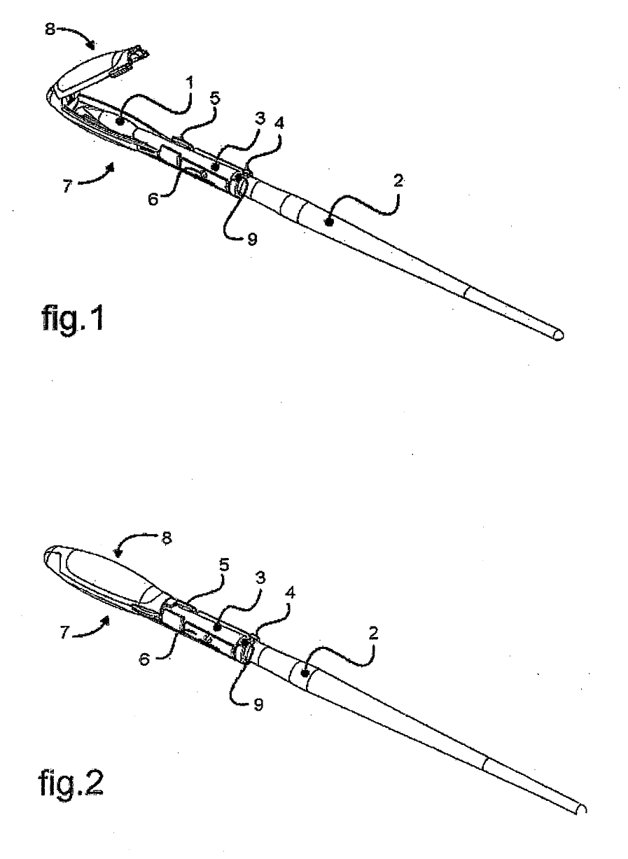

FIG. 1 and FIG. 2 are perspective illustrations of a paintbrush provided with a cap according to the present invention, in the open position and in the closed position of the latter, respectively;

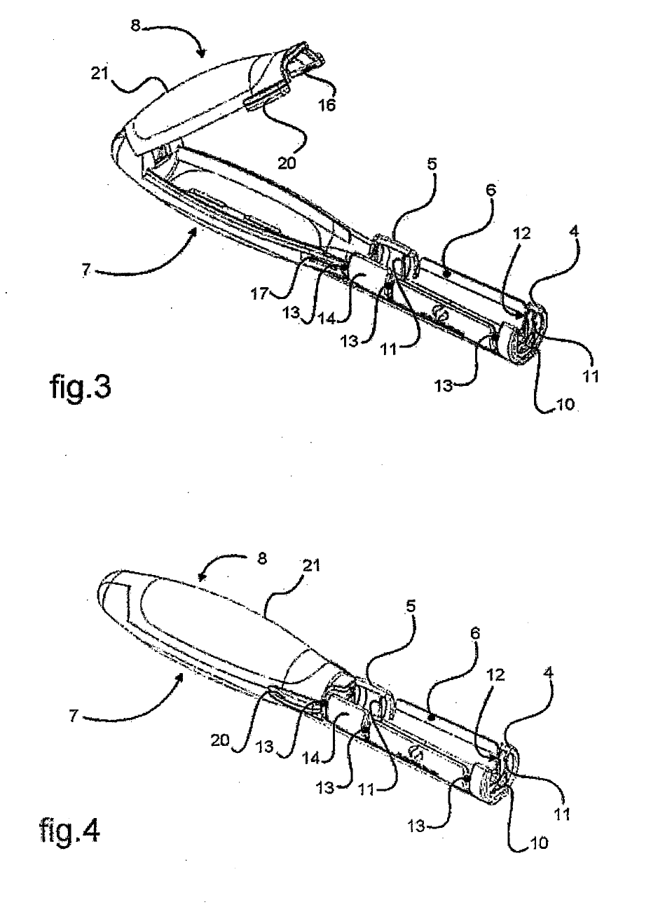

FIG. 3 and FIG. 4 are perspective illustrations of the cap shown in the preceding figures, in the open position and in the closed position of the latter, respectively;

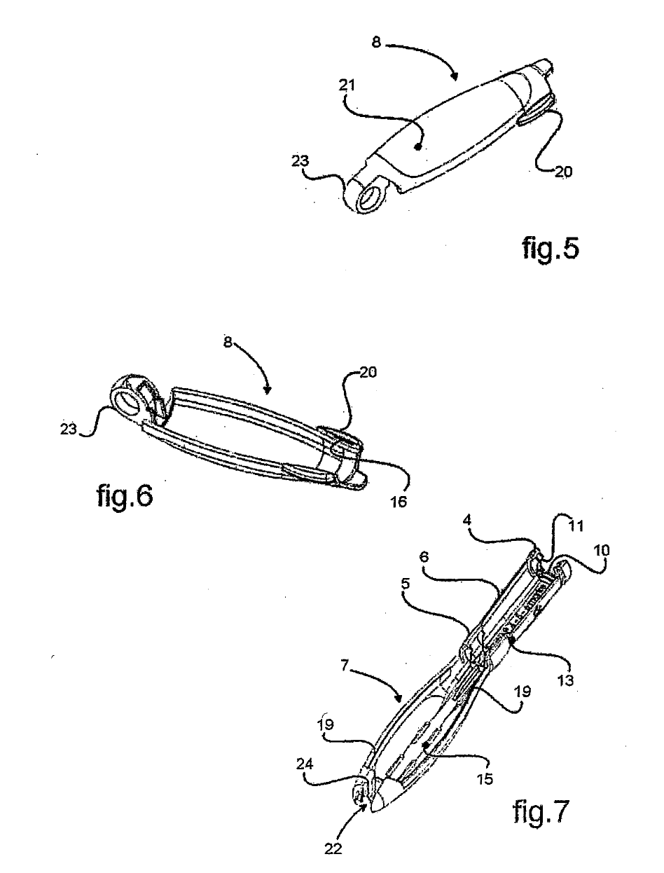

FIG. 5 and FIG. 6 are perspective illustrations of a movable shell forming part of the cap illustrated in the preceding figures, in plan view and in bottom view, respectively;

FIG. 7 is a perspective illustration in plan view of an extended cradle of a fixed shell for forming a monobloc element forming part of a cap illustrated in FIG. 1 to FIG. 4;

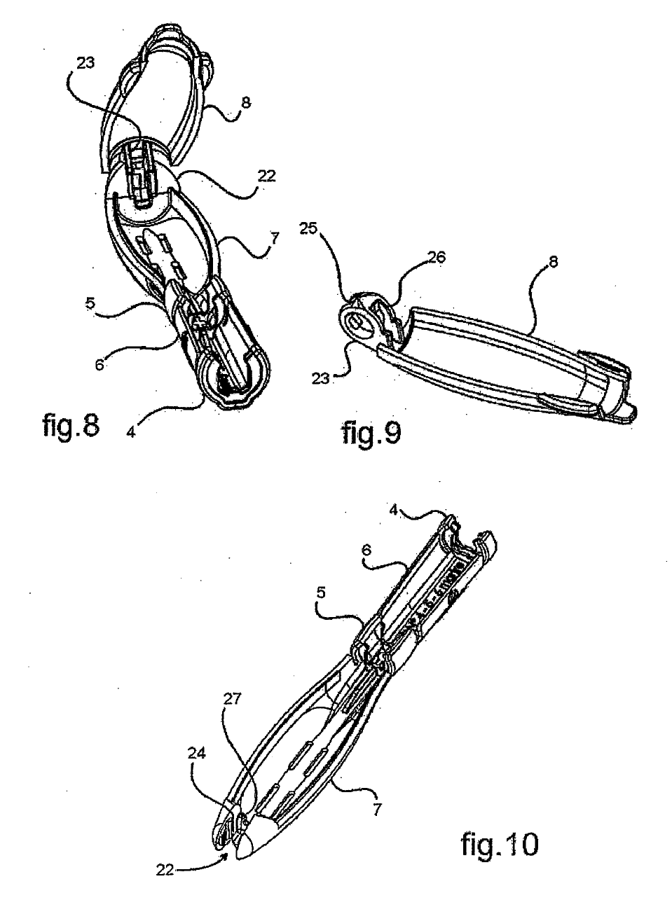

FIG. 8 is a perspective illustration, seen from the proximal end, of a cap according to a preferred variant embodiment of the invention;

FIG. 9 is a perspective illustration of a movable shell of the cap shown in FIG. 8;

FIG. 10 is a perspective illustration of a fixed shell of the cap shown in FIG. 8.

In FIG. 1 and FIG. 2, a paintbrush 1,2,3 is provided with a cap for protecting the bristles 1 it carries at the distal end of its handle 2, to which the bristles are fixed by means of a ferrule 3 crimped onto the handle 2 in the customary manner of the field.

In all, the cap consists of two distinct monobloc elements 6,7 and 8 articulated together. A first element 6,7 is fixed on the ferrule 3 of the paintbrush whereas the proximal end of a second element 8 is mounted movably on the distal end of the first element 6,7. It will be noted that the two elements 6,7 and 8 are advantageously produced by molding and assembled so as to be articulated to one another by nesting.

The first element 6,7 is composed of an elongate cradle 6 integral with a bulbous fixed shell 7, on the distal end of which fixed shell 7 is articulated the second element 8, itself arranged as a bulbous shell 8 rendered movable on the fixed shell 7. The fixed 7 and movable 8 shells together form a housing 7,8 for protecting the bristles 1 of the paintbrush 1,2,3. At this stage of the description, it will be noted that the movable shell 8 includes at least in part a wall 21 made from a transparent material in order to allow the bristles 1 of the paintbrush to be seen by the user through the movable shell 8 despite the housing 7,8 being closed.

The overall ovoid shape of the housing 7,8, which is the result of the bulbous shapes of the shells 7,8 and of their being held together in juxtaposed superimposition, will be more particularly apparent in FIG. 2. This shape of the housing 7,8 gives the cap a particular esthetic appearance, to which the user is deemed to be sensitive, and gives the cap a structure that is free from sharp edges that may constitute areas on which surrounding objects might snag and which might inopportunely retain soiling, given the field of application of the invention.

In FIG. 3 and FIG. 4, the cradle 6 is provided with two members 4,5 for gripping on the ferrule 3 and arranged as an open collar, which gives them an elastically deformable character. A first proximal gripping member 4 interacts, by nesting, with a complementary crimping relief 9 of the ferrule 3 for its at least axial if not, also, radial grip-wise grasping. A second distal gripping member 5 provides radial gripping of the ferrule 3 by the cradle in a distal zone of the latter 3, and even, also, an axial gripping should the ferrule be provided with a second crimping relief in this area.

The gripping members 4,5 are organized in the form of jaws for firm seizing of the ferrule 3. The clamping parts of the jaws consist of a pair of radial lips 12, which are faceted so that each one forms a median finger 10 and two peripheral bearing stops 11 to optimize exploitation of the forces seizing the handle that are generated by means of the elastic deformation of the gripping members 4,5.

It will be noted that these latter 4,5 emanate from the cradle 6, together with which they are formed by molding, being separated from the cradle 6 by slits 13 that promote their deformation without thereby adversely affecting the overall stiffness of the cradle 6.

These arrangements promote easy positioning of the cap on the paintbrush and firm holding of the cap on the ferrule 3, which does not hamper its easy removal by the user.

It will be noted that the cap may be handled by the user without the risk of damaging the bristles 1 protected by the housing 7,8. In fact, when the cap is fitted on the ferrule 3, the proximal gripping member 4 advantageously forms an axial-stop and attaching member for the cap to be placed on the paintbrush, about which proximal member 4 the cap pivots until the distal area of the ferrule 3 is seized by the distal gripping member 5.

The cradle 6 includes, on its outer face, a dorsal stiffening rib 14 extending from its proximal end toward the area where it joins the fixed shell 7. This rib 14 gives the cradle 6 appropriate robustness, without thereby hampering the deformability of the gripping members, particularly against longitudinal flexing of the cradle that is likely to give rise to the spontaneous release of the cap beyond the ferrule 3.

More particularly in FIG. 3, the shells 7,8 include antagonistic longitudinal reliefs 16,17 with radial extension, associating claws 16 provided on the movable shell 8 and recesses 17 for receiving these claws 16 provided on the fixed shell 7. These reliefs 16,17 form means for closure locking of the housing 7,8 by the folding-down of the movable shell toward the fixed shell until they are in juxtaposed superimposition. These antagonistic reliefs 16,17 are preferably provided in the vicinity of the orifice of the shells 7,8 through which the handle 2 of the paintbrush extends. Furthermore, a rabbet 19 is provided at the edge of the periphery of the orifice of the fixed shell 7 in order to guide the movable shell 8 when it is maneuvered and to prevent its skewing, which might adversely affect its articulated link with the fixed shell 7.

The movable shell 8 also includes lateral gripping wings 20 for maneuvering when the housing 7,8 is opened and closed by the user. These wings 20 are provided as a lateral extension of the claws 16 of the movable shell 8, with which claws they interact in order to form a member for strengthening the orifice of the movable shell.

In FIG. 7, the fixed shell 7 includes ventilation slots 15 to allow a sizeable circulation of air between the inner volume of the housing 7,8 and its external environment. The narrow axial extension of these slots allows a circulation of air without thereby significantly adversely affecting the stiffness of the fixed shell 7.

In the variant embodiment illustrated in FIG. 8 to FIG. 10, the cap also includes an air passage to allow, in the closed position, a circulation of air via its distal end. These provisions are aimed at making use of the cap safer, particularly with regard to its unexpected ingestion by a child, the circulation of air through the distal end of the cap allowing the child to breathe, if so required. This air passage is formed by opposite openings made through the fixed shell 7 and the movable shell 8, respectively. More precisely, the fixed shell 7 has, at its distal end, a cover 22 for the articulated reception of a ring 23 of the movable shell 8. The articulated link between the ring 23 and the cover 22 is produced by means of lateral studs 24 of the cover 22 of the fixed shell 7, for receiving the ring 23 by means of nesting. It will be noted that these arrangements of articulated linking of the movable shell 8 to the fixed shell 7 are similar to the corresponding arrangements of the embodiments illustrated in FIG. 1 to FIG. 7.

The opening of the movable shell 8 is composed of two opposite orifices 25 and 26 at the periphery of the ring 23, while the opening of the fixed shell 7 is formed by a radial recess 27 provided on a distal partition of the fixed shell 7, which partition delimits the bottom of the cover 22.

1. A cap for protecting the bristles on the end of a paintbrush, this cap including a housing with means for its easily reversible fixing on a ferrule provided at the distal end of the handle of the paintbrush, with two shells articulated together at one of their ends and capable of being folded down one toward the other in order to close the housing, the latter being provided with means for locking its closure by means of mutual nesting of the shells, wherein one of the shells, which is fixed, is extended by a rigid cradle for receiving the ferrule, this cradle being provided, at least in the vicinity of its respective ends, with members for respective gripping of the ferrule by means of elastic deformation of the members, while the other shell, which is movable, is provided at its distal end with a member for locking in the closed position of the housing by means of juxtaposed superimposition, which interacts by means of nesting with a complementary locking member of the fixed shell.

2. The cap as claimed in claim 1, wherein the gripping members are composed of a proximal member for gripping at least with an axial stop interacting with a complementary relief of the ferrule, and of a distal member for gripping at least with radial retention by means of localized peripheral gripping of the ferrule, such that the attachment of the proximal gripping member on the ferrule 3 of the paintbrush gives this member a pivot-point function, about which the cradle tilts as far as radial gripping of the ferrule by the distal gripping member.

3. The cap as claimed in either of the preceding claims claim 1, wherein the gripping members of the cradle are organized in the form of jaws of which the clamping parts are arranged as at least one radial lip.

4. The cap as claimed in claim 3, wherein the profile of the radial lip is faceted in order to grip the ferrule via distant points.

5. The cap as claimed in claim 1, wherein the cradle includes, on its outer face, a dorsal stiffening rib extending from its proximal end toward the area where it joins the fixed shell.

6. The cap as claimed in claim 5, wherein the dorsal rib and the outer face of the fixed shell are substantially flush.

7. The cap as claimed in claim 1, wherein the locking members of the shells each consist of a set of antagonistic lateral reliefs with radial extension, which are, respectively, provided at the corresponding ends of the shells in a substantially radially median area of the housing.

8. The cap as claimed in claim 1, wherein the housing is provided with means for guiding the movable shell toward the closed position of the housing, formed from interacting guide members of the shells respectively, at the periphery of their orifice.

9. The cap as claimed in claim 8, wherein the interacting members for guiding the shells are formed by a rabbet for mutual superimposed positioning of the shells this, rabbet being provided along the periphery of the orifice of at least either one of the shells in order to receive the edge of the other shell.

10. The cap as claimed in claim 1, wherein the movable shell includes lateral gripping wings enabling it to be gripped and handled at least when the housing is opened by the user.

11. The cap as claimed in claim 8, wherein the lateral gripping wings are provided as an extension of the lateral reliefs f the movable shell in order to strengthen the distal end of the latter forming an orifice for the passage of the handle.

12. The cap as claimed in any one of the preceding claims claim 1, wherein at least either one of the shells includes ventilation openings, particularly shaped as axial slots, such that said openings allow a sizeable circulation of air, without thereby significantly adversely affecting the stiffness of the shell, through the wall of which the ventilation openings are provided.

13. The cap as claimed in claim 1, wherein it includes an air passage to allow, in the closed position, a circulation of air via its distal end.

14. The cap as claimed in claim 13, wherein said air passage is forced by opposite openings made, respectively, through the fixed shell and the movable shell.
